(19) United States
(12) Patent Application Publication
(10) Pub. No.: US 2013/0070651 A1
(43) Pub. Date: Mar. 21, 2013

(54) POWER LINE COMMUNICATION DEVICE, SECURITY LEVEL SETTING METHOD, AND STORAGE MEDIUM STORING SECURITY LEVEL SETTING PROGRAM

(71) Applicant: Naoki Nishizaka, Hadano-shi (JP)

(72) Inventor: Naoki Nishizaka, Hadano-shi (JP)

(73) Assignee: KYOCERA CORPORATION, Kyoto-shi, Kyoto (JP)

(21) Appl. No.: 13/700,243

(22) PCT Filed: May 27, 2011
(86) PCT No.: PCT/JP2011/062286

§ 371 Date: Nov. 27, 2012

(30) Foreign Application Priority Data
May 27, 2010 (JP) 2010-122108

(51) Int. Cl. H04B 3/54

(52) U.S. Cl. CPC H04B 3/546
USPC 370/276

(57) ABSTRACT

According to an aspect, a power line communication device includes a power line communication unit, a process unit, a waveform acquiring unit, a storage unit, a comparing unit, and a security level setting unit. The power line communication unit performs power line communication based on a communication signal superimposed on a carrier wave transmitted via a power line. The waveform acquiring unit acquires a waveform of the communication signal included in the carrier wave transmitted via the power line of the commercial power source. The comparing unit compares waveform information stored in the storage unit with waveform information acquired by the waveform acquiring unit at the time of requiring the process of the process. The security level setting unit changes the security level based on the comparison result by the comparing unit.

### CROSS-REFERENCE TO RELATED APPLICATION

This application is a National Stage of PCT international application Ser. No. PCT/JP2011/062286 filed on May 27, 2011 which designates the United States, and which is based upon and claims the benefit of priority from Japanese Patent Application No. 2010-122108, filed on May 27, 2010.

### FIELD

The present disclosure relates to a power line communication device, a security level setting method, and a storage medium storing a security level setting program.

### BACKGROUND

As a conventional power line communication device, for example, Patent Literature 1 suggests a wireless communication terminal device that performs so-called power line carrier communication using a charging cradle.

### CITATION LIST

### Patent Literature

Patent Literature 1: JP 2003-169004 A

### TECHNICAL PROBLEM

The wireless communication terminal device disclosed in Patent Literature 1 described above leaves a room for improvement, for example, in terms of security.

For the foregoing reasons, there is a need for a power line communication device, a security level setting method, and a security level setting program capable of improving security.

### SUMMARY

According to an aspect, a power line communication device includes a power line communication unit, a process unit, a waveform acquiring unit, a storage unit, a comparing unit, and a security level setting unit. The power line communication unit performs power line communication based on a communication signal superimposed on a carrier wave transmitted via a power line of a commercial power source. A process of the process unit is restricted in accordance with a security level. The waveform acquiring unit acquires a waveform of the communication signal included in the carrier wave transmitted via the power line of the commercial power source. The storage unit stores, as registered waveform information, waveform information corresponding to the waveform of the communication signal acquired in advance by the waveform acquiring unit. The comparing unit compares the registered waveform information stored in the storage unit with comparison waveform information corresponding to the waveform, being acquired by the waveform acquiring unit, of the carrier wave received from the power line of the commercial power source at the time of requiring the process of the process. The security level setting unit changes the security level based on the comparison result obtained by comparing the registered waveform information with the comparison waveform information by the comparing unit.

According to another aspect, the waveform of the communication signal acquired by the waveform acquiring unit is a waveform of a noise component included in the carrier wave transmitted via the power line of the commercial power source.

According to another aspect, the power line communication unit is configured to perform the power line communication using a power waveform from a conversion device for converting the carrier wave transmitted via the power line of the commercial power source into the power waveform used for the power line communication, and the waveform acquiring unit is configured to acquire the waveform included in the power waveform which is not yet converted by the conversion device.

According to another aspect, the process of the process unit is more restricted when the security level is relatively high rather than when the security level is relatively low.

According to another aspect, a wireless communication unit for performing wireless communication with a base station is further included, the storage unit is configured to store, as registered radio-wave information, radio-wave information acquired in advance from the base station by the wireless communication unit in association with the registered waveform information, the comparing unit is configured to compare the registered radio-wave information stored in the storage unit with comparison radio-wave information which is radio-wave information acquired from the base station by the wireless communication unit at the time of requiring the process of the process unit, and the security level setting unit is configured to change the security level based on the comparison result obtained by comparing the registered radio-wave information with the comparison radio-wave information by the comparing unit.

According to another aspect, a GPS information acquiring unit for acquiring GPS information is further included, the storage unit is configured to store the GPS information acquired in advance by the GPS information acquiring unit as registered GPS information in association with the registered waveform information, the comparing unit is configured to compare the registered GPS information stored in the storage unit with comparison GPS information which is GPS information acquired by the GPS information acquiring unit at the time of requiring the process of the process unit, and the security level setting unit is configured to change the security level based on the comparison result obtained by comparing the registered GPS information with the comparison GPS information by the comparing unit.

According to another aspect, the comparison result includes coincidence between the comparison waveform information and the registered waveform information, and the security level setting unit is configured to raise the security level to a relatively high level when the coincidence is relatively low, and lowers the security level to a relatively low level when the coincidence is relatively high.

According to another aspect, the coincidence is expressed by a percentage of the degree of coincidence between the comparison waveform information and the registered waveform information.

According to another aspect, the process unit is configured to include an electronic money processing unit for treating electronic money, and the electronic money processing unit is configured to restrict money to be treated in accordance with the security level, so that the money to be treated relatively decreases when the security level is relatively high, whereas the money to be treated relatively increases when the security level is relatively low.

According to another aspect, the comparison result includes coincidence between the comparison waveform information and the registered waveform information, and the coincidence required so that the electronic money processing unit can be operated is set to be relatively high when remaining money is relatively much, whereas the coincidence required so that the electronic money processing unit can be operated is set to be relatively low when the remaining money is relatively small.

According to another aspect, an operating unit for inputting an authentication operation of changing the security level is further included, and the security level setting unit is configured to change the security level based on the authentication operation input to the operating unit.

According to another aspect, a secondary cell for accumulating power is further included, and the security level setting unit is configured to change the security level to a higher level when the secondary cell is charged.

According to another aspect, a security level setting method is for a power line communication device which is able to perform power line communication based on a communication signal superimposed on a carrier wave transmitted via a power line of a commercial power source and in which a process is restricted in accordance with a security level. The security level setting method includes: acquiring a waveform of the communication signal included in the carrier wave transmitted via the power line of the commercial power source; storing, as registered waveform information, waveform information corresponding to the waveform of the communication signal acquired in advance in the acquiring of the waveform; comparing the registered waveform information stored in the storing of the waveform information with comparison waveform information corresponding to the waveform, being acquired in the acquiring of the waveform, of the carrier wave received from the power line of the commercial power source at the time of requiring the process; and changing the security level based on the comparison result obtained by comparing the registered waveform information with the comparison waveform information in the comparing.

According to another aspect, a security level setting program causes a power line communication device, which is able to perform power line communication based on a communication signal superimposed on a carrier wave transmitted via a power line of a commercial power source and in which a process is restricted in accordance with a security level, to execute: acquiring a waveform of the communication signal included in the carrier wave transmitted via the power line of the commercial power source; storing, as registered waveform information, waveform information corresponding to the waveform of the communication signal acquired in advance in the acquiring of the waveform; comparing the registered waveform information stored in the storing of the waveform information with comparison waveform information corresponding to the waveform, being acquired in the acquiring of the waveform, of the carrier wave received from the power line of the commercial power source at the time of requiring the process; and changing the security level based on the comparison result obtained by comparing the registered waveform information with the comparison waveform information in the comparing.

### ADVANTAGEOUS EFFECTS OF INVENTION

In the power line communication device, the security level setting method, and the security level setting program according to the invention, it is possible to obtain an advantageous effect of improving security.

### BRIEF DESCRIPTION OF DRAWINGS

FIG. 1 is a block diagram illustrating a schematic configuration of an example of a communication system including a mobile communication terminal according to an embodiment.

FIG. 2 is a perspective view illustrating the mobile communication terminal and a power conversion device according to the embodiment.

FIG. 3 is a perspective view illustrating the mobile communication terminal fitted into the power conversion device according to the embodiment.

FIG. 4 is a flowchart illustrating a processing order of a registration process performed by the mobile communication terminal according to the embodiment.

FIG. 5 is a flowchart illustrating a processing order of a security level changing process performed by the mobile communication terminal according to the embodiment.

### DESCRIPTION OF EMBODIMENTS

Hereinafter, the invention will be described in detail with reference to the drawings. The invention is not limited by the following description. Constituent elements to be described below include constituent elements easily assumed by those skilled in the art, substantially identical elements, and constituent elements within a so-called equivalent range.

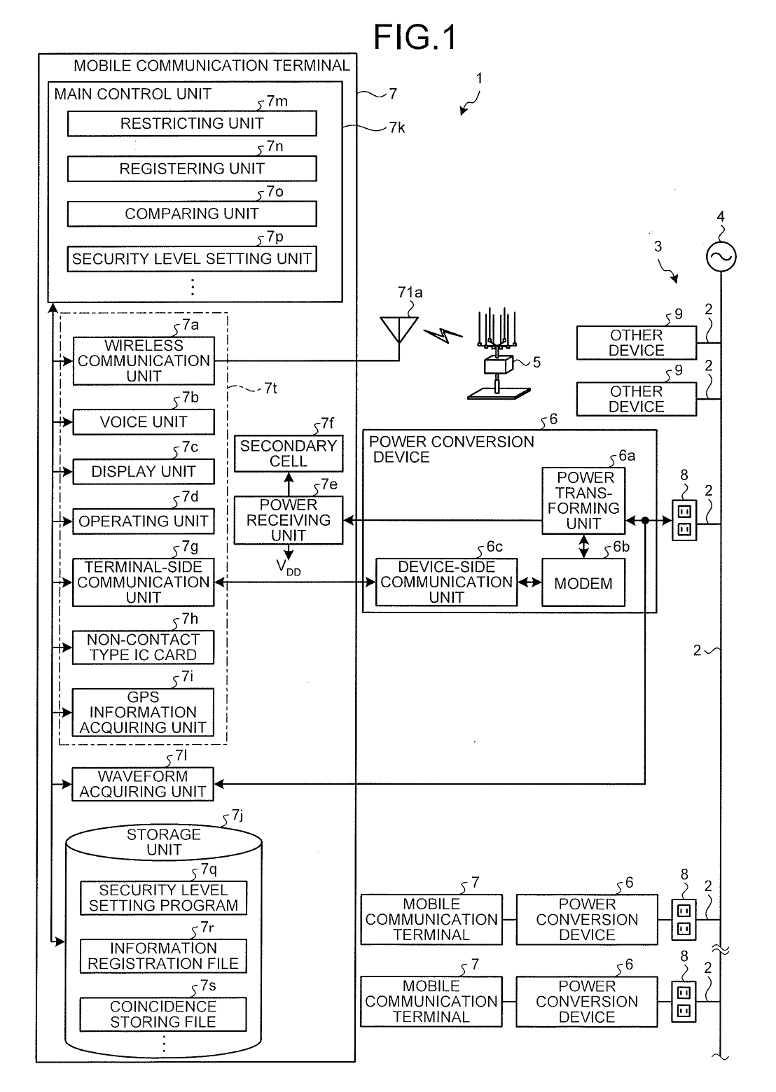

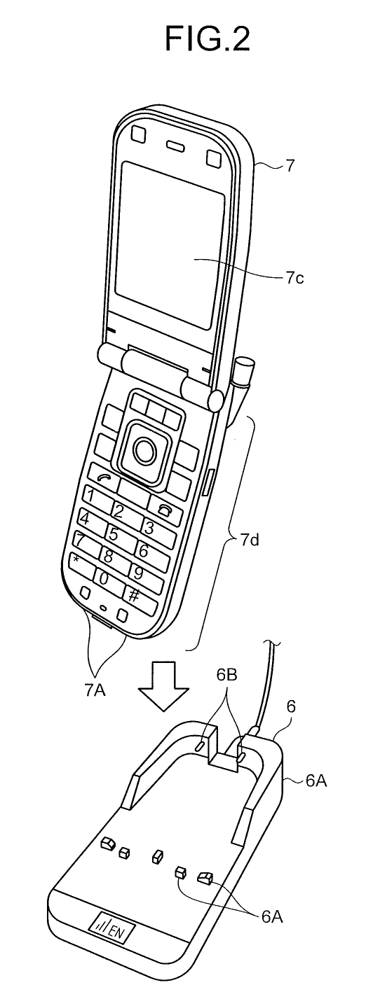

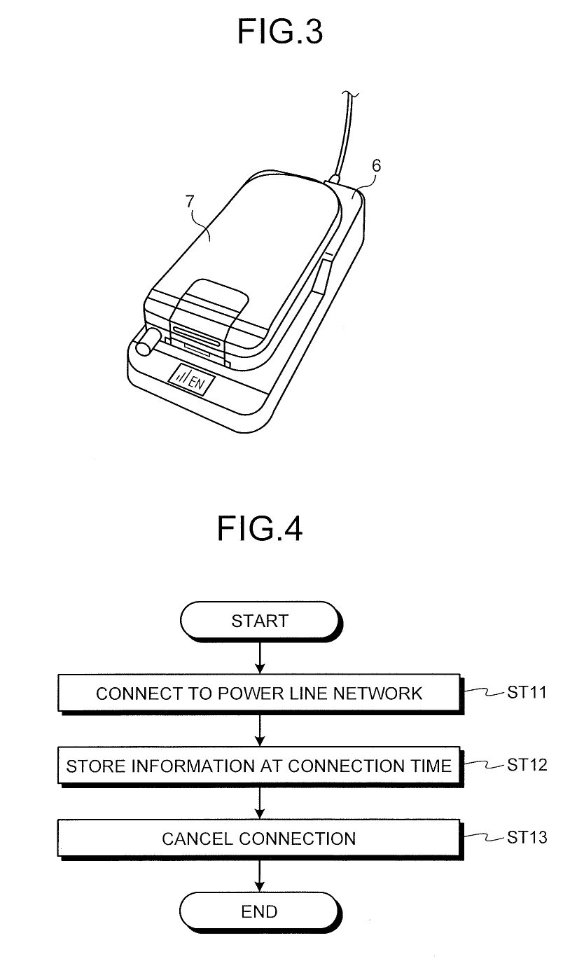

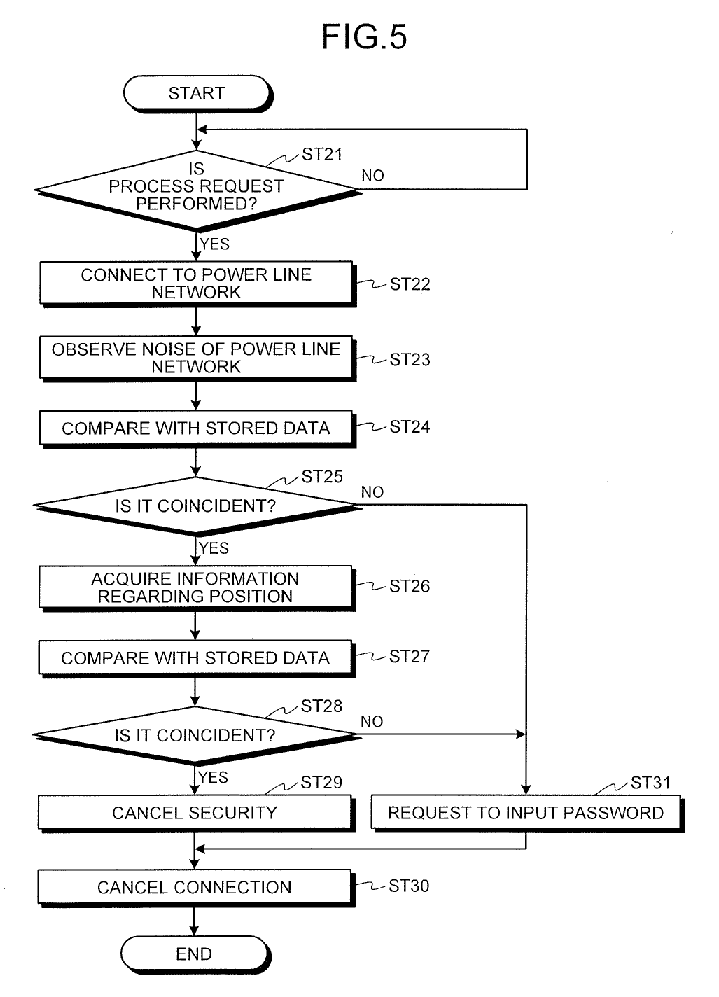

FIG. 1 is a block diagram illustrating a schematic configuration of an example of a communication system including a mobile communication terminal according to an embodiment. FIG. 2 is a perspective view illustrating the mobile communication terminal and a power conversion device according to the embodiment. FIG. 3 is a perspective view illustrating the mobile communication terminal fitted into the power conversion device according to the embodiment. FIG. 4 is a flowchart illustrating a processing order of a registration process performed by the mobile communication terminal according to the embodiment. FIG. 5 is a flowchart illustrating a processing order of a security level changing process performed by the mobile communication terminal according to the embodiment.

The communication system 1 illustrated in FIG. 1 is a system that performs power line communication in which a power line 2 used to supply power is used as a communication path. The communication system 1 can perform both so-called wireless communication and the power line communication.

The power line communication is also called PLC, power line telecommunication (PLT), or power line carrier communication. In general, the power line communication is a technology for using a power wire disposed in a house or an office as a communication line for full-duplex communication that has a bus-type network structure. In the power line communication, a modulation scheme can be adopted which includes orthogonal frequency domain multiplex (OFDM) using high-speed Fourier transform or wavelet transform, spread spectrum (SS) capable of reducing a speed decrease caused due to noise, or discrete multiple frequency (DMT system).

Specifically, the communication system 1 includes a power line network (power line communication network) 3, a commercial power source 4, a base station 5, a power conversion device 6 which is a conversion device, and a mobile communication terminal 7. In the communication system 1, when the mobile communication terminal 7 which is an external electronic device is connected to the power conversion device 6, the mobile communication terminal 7 can perform power line communication. As illustrated FIG. 1, the communication system 1 is configured to include one base station 5 and three pairs of the power conversion devices 6 and the mobile communication terminals 7. However, the embodiment is not limited thereto. The plurality of base stations 5, the plurality of power conversion devices 6, the plurality of mobile communication terminals 7, and the like are disposed on a communication network.

The power line network 3 is a power line communication network that includes the plurality of power lines 2 and enables the above-described power line communication to be performed. The power line 2 is, for example, a path that is connected to a terminal (for example, an outlet) 8 serving as an external power terminal installed in a building, an office, a home, or the like and transports power. The power line 2 supplies the power supplied from the commercial power source 4 to each device via the terminal 8. A communication signal is also superimposed on a carrier wave transmitted by the power line 2.

The commercial power source 4 is a device, a conversion unit, which supplies power generated by a power plant or the like to the power line 2. The commercial power source 4 supplies the power to the power line 2.

The base station 5 is a communication device that wirelessly transmits and receives a communication signal to and from the mobile communication terminal 7 or the like. Further, the base station 5 is connected to other base stations (not illustrated) in a wireless or wired manner, and transmits and receives communication signals to and from the other base stations. Since the base station 5 transmits and receives communication signals to and from the other base station, the communication system 1 forms a communication network. The base station 5 may be connected to a power line network via a power conversion device (not illustrated) or a communication repeater (not illustrated).

The communication signal is a signal of data transmitted and received to perform calling, mail transmission and reception, Internet communication, etc. In the communication system 1, communication (transmission and reception of a communication signal) can be performed with a communication terminal device located in another communication network such as a communication network of another carrier, when a part of the communication network formed by the base station 5 is connected to a switching station.

The power conversion device 6 is a connection device that connects the power line network 3 to the mobile communication terminal 7 to enable the power line communication. The power conversion device 6 converts the power received from the commercial power source 4 into power usable by the mobile communication terminal 7. Further, the power conversion device 6 converts the communication signal superimposed on the carrier wave supplied from the power line 2 into a communication signal that can be received by the mobile communication terminal 7. In the following description, the power conversion device 6 is exemplified as a so-called charging cradle, but the invention is not limited thereto. The power conversion device may also be configured variously as, for example, a relay device that relays the power line network 3 to the mobile communication terminal, an AC adapter that has a power plug and is inserted directly into the terminal 8, or the like.

The mobile communication terminal 7 is a communication terminal (power line communication device) that can transmit and receive a communication signal by the wireless communication and can transmit and receive a communication signal by the power line communication (power line carrier communication). The mobile communication terminal 7 can perform the power line communication via the power line network 3. In the following description, the mobile communication terminal 7 is exemplified as a mobile phone, but the power line communication device is not limited thereto. The power line communication device may be, for example, a PHS, a notebook type PC, a personal digital assistant (PDA), a mobile navigation device, a car navigation in-vehicle device, a data communication device, a mobile game console, or a mobile television.

As illustrated in FIG. 2, the power conversion device 6 is configured such that the mobile communication terminal 7 can be fitted into the power conversion device 6. The mobile communication terminal 7 can engage with the power conversion device 6 via an installation mechanism 6A such as a latch mechanism. Further, the power conversion device 6 is connected to the commercial power source 4 (see FIG. 1) via the power line network 3 (see FIG. 1), and charges the mobile communication terminal 7 with the power from the commercial power source 4. When the mobile communication terminal 7 is fitted into the power conversion device 6 and a power receiving terminal 7A of the mobile communication terminal 7 thus comes into pressure contact with a power-feeding terminal 6B of the power conversion device 6, the charging of the power conversion device 6 starts and is accomplished in the state in which the mobile communication terminal 7 is fitted into the power conversion device 6. As exemplified in FIG. 3, the mobile communication terminal 7 is fitted into the power conversion device 6 to be charged in a folded state. The mobile communication terminal 7 receives the power from the power conversion device 6. The received power is used as operational power of other functions such as the wireless communication of the mobile communication terminal 7 and the power accumulated in a secondary cell 7f (see FIG. 1) of the mobile communication terminal 7. As described above, the mobile communication terminal 7 is connected to the power conversion device 6 to establish a communication line with the power line network 3.

More specifically, as illustrated in FIG. 1, the power conversion device 6 includes a power transforming unit 6a, a modem 6b serving as a modulating and demodulating unit, and an device-side communication unit 6c. The mobile communication terminal 7 includes a wireless communication unit 7a, a voice unit 7b, a display unit 7c, an operating unit 7d, a power receiving unit 7e, the secondary cell 7f, a terminal-side communication unit 7g serving as a power line communication unit, a non-contact type IC card 7h serving as an electronic money processing unit, a GPS information acquiring unit 7i serving as a GPS information acquiring unit, a storage unit 7j, and a main control unit 7k.

The power transforming unit 6a of the power conversion device 6 is connected to the power line 2 forming the power line network 3 via the terminal 8. The power transforming unit 6a is connected between the modem 6b and the power receiving unit 7e of the mobile communication terminal 7. The power transforming unit 6a receives the power fed from the commercial power source 4 via the power line 2 forming the power line network 3, the terminal 8 serving as a power source unit, and the like and transforms the received power into the power usable by the mobile communication terminal 7. The power transforming unit 6a supplies the transformed power to the power receiving unit 7e and the like of the mobile communication terminal 7. The power transforming unit 6a transmits a communication signal superimposed on the power waveform received from the power line 2 forming the power line network 3 to the modem 6b and supplies the communication signal transmitted from the modem 6b to the power line 2 forming the power line network 3 by superimposing the communication signal on the power waveform.

The modem 6b is a modulating and demodulating device that converts the signaling system of the communication signal and performs modulation and demodulation thereof. The modem 6b is connected to the device-side communication unit 6c and the above-described power transforming unit 6a. The modem 6b demodulates the communication signal, which is superimposed on the carrier wave of the power (power waveform) supplied from the commercial power source 4 to the power line 2 forming the power line network 3, the terminal 8, and the power transforming unit 6a and used for the power line communication, into the communication signal used by the mobile communication terminal 7. The modem 6b conversely modulates the communication signal used by the mobile communication terminal 7 into the communication signal used for the power line communication. The modulated communication signal is transmitted from the power transforming unit 6a to the power line 2 forming the power line network 3.

The device-side communication unit 6c is connected to the terminal-side communication unit 7g of the mobile communication terminal 7 and the above-described modem 6b. The device-side communication unit 6c establishes communication with the mobile communication terminal 7, and transmits and receives data to and from the mobile communication terminal 7.

The wireless communication unit 7a of the mobile communication terminal 7 can perform the wireless communication with the base station 5 and another mobile communication terminal or the like via an antenna 71a. The wireless communication unit 7a can perform the communication between the base station 5 and the mobile communication terminal 7 by receiving the communication signal transmitted from the base station 5 and transmitting the communication signal from the mobile communication terminal 7 to the base station 5. That is, the wireless communication unit 7a and the antenna 71a perform the wireless communication of the communication signal transmitted and received between the base station 5 and the mobile communication terminal 7. The wireless communication unit 7a performs the wireless communication in conformity with a scheme such as a time division multiplexing scheme, in which each of a plurality of time slots time-divided from a frame in the base station 5 is allocated to a cannel of the mobile communication terminal 7 to perform the communication, and the like.

The voice unit 7b includes a receiver, a microphone, etc. The receiver outputs a voice at the calling time. The microphone receives a voice at the calling time.

The display unit 7c includes a display panel configured by a liquid crystal display, an organic EL panel, or the like. For example, the display unit 7c displays various kinds of information such as a video corresponding to video data and an image corresponding to image data supplied from the main control unit 7k to be described below.

The operating unit 7d includes various keys such as number keys, a direction key, a determination key, a function key, and a specific key. The operating unit 7d is connected to the main control unit 7k. When the above-mentioned key is input through a user's operation, the operating unit 7d generates a signal corresponding to the operation. For example, the signal generated by the operating unit 7d is processed suitably by an input data acquiring unit or the like and is input, as an instruction of the user, to the main control unit 7k to be described below.

An authentication operation of manually changing a security level to be described below is also input by the operating unit 7d. The authentication operation is generally various operations of individually authenticating a user and is, for example, an operation of inputting a predetermined password set in advance or inputting biometric information used for biometric authentication or the like.

The power receiving unit 7e receives the power, which is transformed by the power transforming unit 6a of the power conversion device 6, from the power transforming unit 6a, and then converts the power into power with a voltage suitable for each circuit of the mobile communication terminal 7 and supplies the converted power. Further, the power receiving unit 7e supplies the power to the secondary cell 7f to charge the secondary cell 7f, while the mobile communication terminal 7 is fitted into the power conversion device 6.

The secondary cell 7f accumulates some of the power received by the power receiving unit 7e, and supplies the power to each circuit of the mobile communication terminal 7 instead of the power receiving unit 7e, when the mobile communication terminal 7 is detached from the power conversion device 6.

The terminal-side communication unit 7g establishes the communication with the power line network 3 via the device-side communication unit 6c and the modem 6b of the power conversion device 6. That is, the terminal-side communication unit 7g performs the power line communication via the power conversion device 6 that converts the power received from the commercial power source 4 into the available power. The terminal-side communication unit 7g performs the power line communication based on the communication signal superimposed on the commercial power source 4, as described above. More specifically, the terminal-side communication unit 7g performs the power line communication based on the communication signal superimposed on the carrier wave transmitted via the power line 2 of the commercial power source 4. In other words, the terminal-side communication unit 7g performs the power line communication using the waveform of the power from the power conversion device 6 that converts the carrier wave transmitted via the power line 2 of the commercial power source 4 into the waveform usable for the power line communication.

The non-contact type IC card 7h is a non-contact type dedicated communication unit and is specifically an IC chip that performs communication with a short range wireless communication unit. Here, for example, the non-contact type IC card 7h functions as an electronic money processing unit that treats electronic money. The non-contact type IC card 7h includes a plurality of storage regions, in which various kinds of electronic money or the like are stored. Information regarding the electronic money includes identification information and information regarding remaining money. Further, the non-contact type IC card 7h performs communication with the short range wireless communication unit to transmit the stored information to the short range wireless communication unit and receive information transmitted from the short range wireless communication unit. The non-contact type IC card 7h stores the received information. That is, the non-contact type IC card 7h can rewrite the stored information through the communication with the short range wireless communication unit. Furthermore, the non-contact type IC card 7h reads and rewrites information under the control of the main control unit 7k. Thus, the non-contact type IC card 7h updates the stored information or rewrites the information regarding remaining money or the like according to the use or charge by reading and rewriting information under another communication unit or the main control unit 7k.

The GPS information acquiring unit 7i is a communication unit that can receive a GPS signal transmitted from a GPS satellite to acquire the GPS information. The GPS information acquiring unit 7i calculates a latitude, a longitude, or the like of the mobile communication terminal 7 as GPS information based on the received GPS signal and transmits positional information such as the calculated latitude, longitude, or the like to the main control unit 7k.

The storage unit 7j is configured by a ROM, a RAM, an E2PROM, a non-volatile RAM, a flash memory, an HDD, or the like and stores various software programs or data used in a process of the main control unit 7k.

The main control unit 7k is a processing unit such as a central processing unit (CPU) that integrally manages and controls the overall process of the mobile communication terminal 7. The main control unit 7k controls the operations of a process unit 7t including the wireless communication unit 7a, the voice unit 7b, the display unit 7c, the operating unit 7d, the terminal-side communication unit 7g, the non-contact type IC card 7h, and the GPS information acquiring unit 7i such that various processes of the mobile communication terminal 7 are performed in an appropriate order in response to an operation of the operating unit 7d or in accordance with a software program stored in the storage unit 7j of the mobile communication terminal 7. The main control unit 7k performs various processes by executing a program (for example, an operating system program or an application program) stored in the storage unit 7j, referring to data stored in the storage unit 7j, as necessary. The program executed or the data referred to by the main control unit 7k may be downloaded from a server through the wireless communication performed by the wireless communication unit 7a or the power line communication performed by the terminal-side communication unit 7g.

In the communication system 1 having the above-described configuration, when the mobile communication terminal 7 is fitted into the power conversion device 6 and the power receiving terminal 7A of the mobile communication terminal 7 comes into pressure contact with the power-feeding terminal 6B of the power conversion device 6, the power of the commercial power source 4 is transformed into the power usable by the mobile communication terminal 7 in the power conversion device 6. In this state, the mobile communication terminal 7 can transmit and receive a communication signal through the power line communication with the power line network 3 via the terminal-side communication unit 7g and the power conversion device 6. At this time, the modem 6b of the power conversion device 6 demodulates the communication signal superimposed on the commercial power source 4 and modulates the communication signal of the mobile communication terminal 7. Thus, the device-side communication unit 6c establishes the communication with the mobile communication terminal 7. For example, the mobile communication terminal 7 converts the received communication signal into a voice, a character string, or an image and outputs the result to the voice unit 7b, the display unit 7c, or the like. Further, the mobile communication terminal 7 converts a voice, character information, or an image input via the voice unit 7b, the operating unit 7d, or the like into a communication signal and outputs the converted communication signal to the base station 5 or the power line network 3. The mobile communication terminal 7 can perform calling, mail transmission and reception, access to a web site, or the like by transmitting and receiving a communication signal to and from another communication terminal via the base station 5, the power line network 3, or the like.

A communication device needs to be further improved in terms of security.

The power line 2 is originally not designed to perform communication. Therefore, since the power line 2 is connected to a plurality of other devices 9 other than the mobile communication terminal 7 as a target, the plurality of other devices 9 act as noise sources. For this reason, in the power of the power line 2, voltage variation or noise occurs depending on a use status or the like of the plurality of other devices 9. Accordingly, a waveform included in the power received from the commercial power source 4 by the mobile communication terminal 7 or the like, in other words, a waveform of a noise component included in the power received from the commercial power source 4 by the mobile communication terminal 7 or the like is basically different at each power reception position, at which the power is received, depending on the use status or the like of other devices 9 near the power reception position, for example. Conversely, the waveform included in the power received from the commercial power source 4 by the mobile communication terminal 7 or the like has a tendency to some extent at each power reception position, at which the power is received, depending on the use status or the like of other devices 9 near the power reception position. Therefore, the tendency of the waveform can be used to identify the specific power reception position, that is, the specific terminal 8.

In the mobile communication terminal 7 according to the embodiment, this fact is used to set security. For example, when a specific mobile communication terminal 7 is used at a specific power reception position, the level of security is automatically lowered. On the other hand, at other positions, the level of the security can be automatically raised. In this way, the security can be designed to be improved and the troublesome work of setting of the security can be designed to be reduced.

Specifically, as illustrated in FIG. 1, the mobile communication terminal 7 includes a waveform acquiring unit 7l. Further, the main control unit 7k includes a restricting unit 7m, a registering unit 7n, a comparing unit 7o, and a security level setting unit 7p in terms of a functional concept. A security level setting process including a registering process and a security level changing process to be described below is realized basically by causing the main control unit 7k to read and execute a security level setting program 7q from the storage unit 7j.

As described above, the mobile communication terminal 7 includes the process unit 7t including the wireless communication unit 7a, the voice unit 7b, the display unit 7c, the operating unit 7d, the terminal-side communication unit 7g, the non-contact type IC card 7h, the GPS information acquiring unit 7i, etc. The process of the process unit 7t is restricted in accordance with the security level set by the security level setting unit 7p.

hereinafter, the mobile communication terminal 7 will be described on the assumption that the process of the non-contact type IC card 7h is restricted, but the embodiment is not limited thereto. For example, all of the processes of the process unit 7t, that is, all of the processes of the mobile communication terminal 7 may be restricted.

The waveform acquiring unit 7l can acquire a waveform included in the power received from the commercial power source 4. More specifically, the waveform acquiring unit 7l can acquire the waveform of a communication signal included in a carrier wave transmitted via the power line 2 of the commercial power source 4. In the embodiment, the waveform included in the power received from the commercial power source 4 will be described as a waveform of a noise component included in the power received from the commercial power source 4, but the waveform is not limited thereto. The waveform may be a waveform of a component with which a specific power reception position can be identified. More specifically, the waveform of the communication signal acquired by the waveform acquiring unit 7l will be described as the waveform of a noise component included in a carrier wave transmitted via the power line 2 of the commercial power source 4, but the waveform is not limited thereto. The waveform may be a waveform of a component with which a specific power reception position can be identified. The waveform acquiring unit 7l acquires the waveform of a noise component included in the power received from the commercial power source 4 as the waveform included in the power received from the commercial power source 4. More specifically, the waveform acquiring unit 7l acquires the waveform of a noise component that is included in the power received by the power conversion device 6 and that is the power which is not transformed (converted) into the power available in the mobile communication terminal 7 by the power transforming unit 6a. In other word, the waveform acquiring unit 7l acquires the waveform included in the power waveform which is not transformed by the power conversion device 6. The noise component is an unnecessary component other than the component to be processed in the power line communication or the like, which is not used in the power line communication or the like. The waveform acquiring unit 7l may be realized as a function of the main control unit 7k.

The restricting unit 7m restricts the process of the process unit 7t in accordance with the security level set by the security level setting unit 7p to be described below. In the embodiment, the restricting unit 7m restricts the process of the non-contact type IC card 7h. The restricting unit 7m restricts the process of the process unit 7t more strictly, when a relatively high security level is set. The restricting unit 7m restricts the process of the process unit 7t loosely, when a relatively low security level is set. That is, the process of the process unit 7t is more restricted when the security level is relatively high than when the security level is relatively low. When the minimum security level is set, for example, the restricting unit 7m may set the process of the process unit 7t to be not restricted, in other word, may cancel the security of the process unit 7t.

For example, the restricting unit 7m restricts the money which the non-contact type IC card 7h can treat with in accordance with the security level, when the process unit 7t is thus configured to include the non-contact type IC card 7h and the restricting unit 7 restricts the process of the non-contact type IC card 7h in accordance with the security level. For example, the process of the non-contact type IC card 7h is restricted by the restricting unit 7m such that the money to be treated is set relatively small when the security level is relatively high. On the other hand, the process of the non-contact type IC card 7h is restricted by the restricting unit 7m such that the money to be treated is set relatively much when the security level is relatively low.

The registering unit 7n stores and registers the waveform of the noise component acquired in advance by the waveform acquiring unit 7l as registered waveform information in an information registration file 7r of the storage unit 7j. In other words, registering unit 7n stores and registers waveform information corresponding to the waveform of the communication signal acquired in advance by the waveform acquiring unit 7l as registered waveform information in an information registration file 7r of the storage unit 7j. The registered waveform information (registered waveform data) is waveform information of a noise component at a specific power reception position at which the mobile communication terminal 7 is used and is noise component waveform information (noise waveform data) serving as a reference used to identify that the current actual power reception position (connection position) is a specific power reception position (specific connection position), when the mobile communication terminal 7 receives the power from the commercial power source 4 via the power conversion device 6. For example, the registering unit 7n registers the noise component waveform information acquired by the waveform acquiring unit 7l as the registered waveform information, when the mobile communication terminal 7 is connected to the power line network 3 via the power conversion device 6 at a specific power reception position (specific connection position) selected arbitrarily by a user or the like and receives the power from the commercial power source 4 via the power conversion device 6.

The comparing unit 7o compares comparison waveform information, which is information regarding the waveform received from the commercial power source 4 at the time of requiring the process of the process unit 7t and acquired by the waveform acquiring unit 7l, to the registered waveform information stored in the storage unit 7j. In other words, the comparing unit 7o compares the comparison waveform information corresponding to the waveform, which is acquired by the waveform acquiring unit 7l with respect to the carrier wave received from the power line 2 of the commercial power source 4 at the time of requiring the process of the process unit 7t, to the registered waveform information stored in the storage unit 7j. The comparing unit 7o reads, as the comparison waveform information, information regarding the waveform of a current noise component acquired by the waveform acquiring unit 7l at the time of requiring the process of the process unit 7t, and reads the registered waveform information from the information registration file 7r of the storage unit 7j. Then, the comparing unit 7o compares the comparison waveform information to the registered waveform information. The time of requiring the process of the process unit 7t is, for example, the time of requiring payment of the non-contact type IC card 7h which is the process unit 7t.

The comparison result obtained by the comparing unit 7o according to the embodiment includes the coincidence between the comparison waveform information and the registered waveform information. That is, for example, the comparing unit 7o calculates the coincidence between the waveform of the current noise component indicated by the comparison waveform information and the waveform of the noise component at the registration time indicated by the registered waveform information by comparing and checking the waveform of the current noise component indicated by the comparison waveform information and the waveform of the noise component at the registration time indicated by the registered waveform information using various analyses such as the spectral analysis. The coincidence is, for example, expressed by a correlation level or an authentication level such as an authentication ratio obtained by calculating the degree of coincidence between the comparison waveform information and the registered waveform information by a percentage. The comparing unit 7o stores information regarding the calculated coincidence as the comparison result between the comparison waveform information and the registered waveform information in the coincidence storing file 7s.

The security level setting unit 7p sets the security level used to restrict the process unit 7t. The security level setting unit 7p changes the security level used to restrict the process unit 7t based on the comparison result (the result of comparison) between the comparison waveform information and the registered waveform information in the comparing unit 7o. The security level setting unit 7p adjusts the security level in accordance with the coincidence between the comparison waveform information and the registered waveform information. The security level setting unit 7p reads the information regarding the coincidence between the comparison waveform information and the registered waveform information stored in the coincidence storing file 7s and changes the security level in accordance with the coincidence between the comparison waveform information and the registered waveform information.

Specifically, the security level setting unit 7p sets the security level to be relatively high, when the coincidence is relatively low. When the coincidence is relatively low, it can be assumed that there is a high probability that the mobile communication terminal 7 is connected to the power line network 3 at a power reception position other than a specific preset power reception position and receives the power. Therefore, the security level setting unit 7p raises the security by setting the security level for restricting the process unit 7t to be relatively high. On the other hand, the security level setting unit 7p sets the security level to be relatively low, when the coincidence is relatively high. When the coincidence is relatively high, it can be assumed that there is a high probability that the mobile communication terminal 7 is connected to the power line network 3 at the specific preset power reception position and receive the power. Therefore, the security level setting unit 7p lowers the security by setting the security level for restricting the process unit 7t to be relatively low. The number of security levels set by the security level setting unit 7p is not limited to two stages, but may be three or more stages.

As described above, the process of the non-contact type IC card 7h is restricted such that the money to be treated is relatively much, when the security level is relatively low. In other words, when the remaining money is relatively much, the coincidence required so that the non-contact type IC card 7h can be operated to treat all the money is set to be relatively high between the comparison waveform information and the registered waveform information. The process of the non-contact type IC card 7h is restricted such that the money to be treated is relatively small, when the security level is relatively high. In other words, when the remaining money is relatively small, the coincidence required so that the non-contact type IC card 7h can be operated to treat all the money is set to be relatively low between the comparison waveform information and the registered waveform information. Thus, for example, when the remaining electronic money is high, the mobile communication terminal 7 can raise the security level automatically. That is, the security can be further improved.

When the mobile communication terminal 7 having the above-described configuration is used at a specific power reception position selected in advance by a user or the like, in other words, the mobile communication terminal 7 is used via the specific terminal 8, the mobile communication terminal 7 can lower the security level automatically based on the comparison result between the comparison waveform information and the registered waveform information. On the other hand, when the mobile communication terminal 7 is used at a power reception position other than the specific power reception position, in other words, the mobile communication terminal 7 is used via the terminal 8 other than the specific terminal 8, the mobile communication terminal 7 can raise the security level automatically based on the comparison result between the comparison waveform information and the registered waveform information. As a result, the mobile communication terminal 7 can improve the security and reduce a troublesome work of manually changing the setting of the security to use the mobile communication terminal 7 at the specific power reception position.

For example, when the mobile communication terminal 7 is connected to the power line network 3 and is connected from a PC or the like via the power line network 3 or the like to require a predetermined process such as payment of the electronic money, the mobile communication terminal 7 lowers the security level automatically to cancel the restriction on the process by using, as a trigger, the fact that the coincidence between the current noise status of the power received from the power line network 3 and a reference noise status registered in advance is equal to or greater than a predetermined value. Thus, the mobile communication terminal 7 can reduce the troublesome work such as an operation of inputting a password or a biometric authentication operation to cancel the restriction of the process, when the mobile communication terminal 7 receives the power at the specific power reception position.

Further, for example, the mobile communication terminal 7 can identify the specific power reception position suitable for the mobile communication terminal 7 based on the waveform information of the noise component included in the power received from the commercial power source 4 from a plurality of power reception positions, such as different floors of the same building, at which so-called position information of the mobile communication terminal 7 is the same. Therefore, the security level can be appropriately set.

The mobile communication terminal 7 according to the embodiment is configured to further improve security by setting the security level automatically based on the position information of the mobile communication terminal 7. The mobile communication terminal 7 according to the embodiment includes the above-described wireless communication unit 7a as a position information acquiring unit that can acquire the position information of the mobile communication terminal 7.

The wireless communication unit 7a can perform wireless communication with the base station 5, another mobile communication terminal, or the like via the antenna 71a, as described above, and also functions as the position information acquiring unit that can acquire the position information of the mobile communication terminal 7. The registering unit 7n stores and registers the position information of the mobile communication terminal 7 acquired in advance by the wireless communication unit 7a as registered position information in association with the above-described registered waveform information in the information registration file 7r of the storage unit 7j. The registered position information is position information of the mobile communication terminal 7 at a specific power reception position at which the mobile communication terminal 7 is used, and is position information serving as a reference used to identify that the mobile communication terminal 7 is currently located near the specific power reception position (specific connection position), when the mobile communication terminal 7 receives the power from the commercial power source 4 via the power conversion device 6. For example, the registering unit 7n registers the position information of the mobile communication terminal 7 acquired by the wireless communication unit 7a as the registered position information, when the mobile communication terminal 7 is connected to the power line network 3 via the power conversion device 6 and receives the power from the commercial power source 4 via the power conversion device 6 at the specific power reception position (specific connection position) arbitrarily selected by a user or the like.

As in the case of the comparison between the comparison waveform information and the registered waveform information, the comparing unit 7o compares the registered position information stored in the storage unit 7j with comparison position information, which is the position information acquired by the wireless communication unit 7a at the time of requiring the process of the process unit 7t. The security level setting unit 7p changes the security level to restrict the process unit 7t based on the comparison result between the comparison position information and the registered position information obtained by the comparing unit 7o.

Specifically, the wireless communication unit 7a acquires radio-wave information from the base station 5 as information corresponding to the position information of the mobile communication terminal 7. Since the radio-wave information acquired by the base station 5 includes information regarding the base station with which the mobile communication terminal 7 performs the wireless communication and information such as a received signal strength indicator (RSSI) indicating the strength of a signal, the position information of the mobile communication terminal 7 can be specified based on the information regarding the base station and the information such as the RSSI.

The registering unit 7n stores and registers, as registered radio-wave information (corresponding to the registered position information), the radio-wave information acquired in advance from the base station 5 by the wireless communication unit 7a in association with the above-described registered waveform information in the information registration file 7r of the storage unit 7j. The radio-wave information is radio-wave information from the base station 5 at the specific power reception position at which the mobile communication terminal 7 is used, and is radio-wave information serving as a reference used to identify that the mobile communication terminal 7 is currently located near the specific power reception position (specific connection position), when the mobile communication terminal 7 receives the power from the commercial power source 4 via the power conversion device 6. For example, the registering unit 7n registers the radio-wave information from the base station 5 acquired by the wireless communication unit 7a as the registered radio-wave information, when the mobile communication terminal 7 is connected to the power line network 3 via the power conversion device 6 and receives the power from the commercial power source 4 via the power conversion device 6 at the specific power reception position (specific connection position) arbitrarily selected by a user or the like.

As in the case of the comparison between the comparison waveform information and the registered waveform information, the comparing unit 7o compares the registered radio-wave information stored in the storage unit 7j with comparison radio-wave information (corresponding to the comparison position information), which is radio-wave information acquired from the base station 5 by the wireless communication unit 7a at the time of requiring the process of the process unit 7t. The security level setting unit 7p changes the security level to restrict the process unit 7t based on the comparison result between the comparison radio-wave information and the registered radio-wave information obtained by the comparing unit 7o.

As a result, the mobile communication terminal 7 can further improve the security by automatically setting the security level based on not only the waveform information of the noise component included in the power received from the commercial power source 4 but also the position information of the mobile communication terminal 7, in the embodiment, the radio-wave information from the base station 5. For example, the mobile communication terminal 7 can accurately identify the specific power reception position selected in advance by the user or the like, in other words, the specific terminal 8 based on the position information of the mobile communication terminal 7, in the embodiment, the radio-wave information from the base station 5 from the plurality of power reception positions, at which the waveform information of the noise component included in the power received from the commercial power source 4 is similar. Accordingly, the mobile communication terminal 7 can identify the specific power reception position more reliably, in other words, the specific terminal 8, and can set the security level more accurately according thereto.

As described above, the mobile communication terminal 7 includes the operating unit 7d to which an authentication operation (for example, an operation of inputting a predetermined password or inputting biometric information used for biometric authentication or the like) of changing the security level is input. The security level setting unit 7p may be configured to change the security level based on the authentication operation input to the operating unit 7d. The security level setting unit 7p may change the security level to a relatively low security level in a case where an appropriate authentication operation is performed via the operating unit 7d, for example, when the coincidence between the comparison waveform information and the registered waveform information is less than or equal to a predetermined value. Thus, the mobile communication terminal 7 can manually change the security level arbitrarily by the user.

Then, an example of a security level setting method and a security level setting program performed by the mobile communication terminal 7 will be described with reference to the flowcharts of FIGS. 4 and 5. The security level setting process including a registering process and a security level changing process to be described below is realized by causing the main control unit 7k to execute the security level setting program 7q.

The main control unit 7k performs, at first of the registering process illustrated in FIG. 4, a process of controlling the process of the terminal-side communication unit 7g, in the state in which the mobile communication terminal 7 is connected to the power conversion device 6, and connecting the mobile communication terminal 7 to the power line network 3 via the power conversion device 6 or the like (Step ST11).

Subsequently, the main control unit 7k performs a process of storing information at the connection time (Step ST12). That is, the main control unit 7k performs a process of controlling the process of the waveform acquiring unit 7l and acquiring the waveform of a noise component included in the power received from the commercial power source 4. Then, the registering unit 7n of the main control unit 7k performs a process of storing the waveform of the noise component acquired by the waveform acquiring unit 7l as the registered waveform information (corresponding to the information at the connection time) in the information registration file 7r of the storage unit 7j. At this time, the main control unit 7k further performs a process of controlling the process of the wireless communication unit 7a and acquiring the position information of the mobile communication terminal 7, in the embodiment, the radio-wave information from the base station 5. Then, the registering unit 7n performs a process of storing the position information acquired by the wireless communication unit 7a, in the embodiment, the radio-wave information from the base station 5 as the registered position information, in the embodiment, the registered radio-wave information (corresponding to the information at the connection time) in association with the registered waveform information in the information registration file 7r of the storage unit 7j.

Subsequently, the main control unit 7k performs a process of controlling the process of the terminal-side communication unit 7g and cancelling the connection between the mobile communication terminal 7 and the power line network 3 (Step ST13), and ends the registering process.

Then, the main control unit 7k performs, at first of the security level changing process illustrated in FIG. 5, a process of determining whether a process request of the process unit 7t, for example, a payment request by the non-contact type IC card 7h is performed in the state in which the mobile communication terminal 7 is connected to the power conversion device 6 (Step ST21). When it is determined that the process request of the process unit 7t is not performed (No at Step ST21), the main control unit 7k repeatedly performs the determining process of Step ST21 until determining that the process request of the process unit 7t is performed.

When it is determined that the process request of the process unit 7t is performed (Yes at Step ST21), the main control unit 7k performs a process of controlling the process of the terminal-side communication unit 7g and connecting the mobile communication terminal 7 to the power line network 3 via the power conversion device 6 or the like (Step ST22).

Subsequently, the main control unit 7k performs a process of observing the waveform of noise of the power line network, that is, the noise component included in the power received from the commercial power source 4 (Step ST23). That is, the main control unit 7k performs a process of controlling the process of the waveform acquiring unit 7l and acquiring the comparison waveform information which is the information regarding the waveform of the noise component included in the power received from the commercial power source 4 at the time of requiring the process of the process unit 7t.

Subsequently, the comparing unit 7o of the main control unit 7k performs a process of comparing the comparison waveform information acquired at Step ST23 with the stored data stored at Step ST12, that is, the registered waveform information (Step ST24). That is, the comparing unit 7o performs a process of comparing the comparison waveform information, which is information regarding the waveform acquired in the process (Step ST23) of performing the power reception and the acquisition from the commercial power source 4 at the time of requiring the process of the process unit 7t, with the registered waveform information stored in the storing process (Step ST12)

Subsequently, the comparing unit 7o performs the process of determining whether the comparison waveform information coincides with the registered waveform information (Step ST25). For example, the comparing unit 7o determines whether the comparison waveform information coincides with the registered waveform information by determining whether the coincidence between the comparison waveform information and the registered waveform information is equal to or greater than a preset coincidence determination value.

When the comparing unit 7o determines that the comparison waveform information coincides with the registered waveform information (Yes at Step ST25), the main control unit 7k performs the process of acquiring the position information of the mobile communication terminal 7 (Step ST26). That is, the main control unit 7k performs a process of controlling the process of the wireless communication unit 7a and acquiring the comparison position information which is the position information of the mobile communication terminal 7 at the time of requiring the process of the process unit 7t, in the embodiment, the comparison radio-wave information which is the radio-wave information from the base station 5 at the time of requiring the process of the process unit 7t.

Subsequently, the comparing unit 7o of the main control unit 7k performs of comparing the comparison position information acquired at Step ST26, in the embodiment, the comparison radio-wave information with the stored data stored at Step ST12, that is, the registered position information, in the embodiment, the registered radio-wave information (Step ST27). That is, the comparing unit 7o performs a process of comparing the comparison radio-wave information (comparison position information) acquired by the wireless communication unit 7a at the time of requiring the process of the process unit 7t with the registered radio-wave information (registered position information) stored at the storing process (Step ST12).

Subsequently, the comparing unit 7o performs a process of determining whether the comparison radio-wave information (comparison position information) coincides with the registered radio-wave information (registered position information) (Step ST28). For example, the comparing unit 7o determines whether the comparison radio-wave information (comparison position information) coincides with the registered radio-wave information (registered position information) by determining whether the coincidence between the comparison radio-wave information (comparison position information) and the registered radio-wave information (registered position information) is equal to or greater than the preset coincidence determination value.

When the comparing unit 7o determines that the comparison radio-wave information (comparison position information) coincides with the registered radio-wave information (registered position information) (Yes at Step ST28), the security level setting unit 7p of the main control unit 7k performs a process of cancelling the security (Step ST29). That is, the security level setting unit 7p changes the security level to the minimum level so that the restriction on the process of the process unit 7t by the restricting unit 7m is withdrawn.

Subsequently, the main control unit 7k performs a process of controlling the process of the terminal-side communication unit 7g and cancelling the connection between the mobile communication terminal 7 and the power line network 3 (Step ST30) and ends the security level changing process.

When the comparing unit 7o determines that the comparison waveform information does not coincide with the registered waveform information at Step ST25 (No at Step ST25) or the comparing unit 7o determines that the comparison radio-wave information (comparison position information) does not coincide with the registered radio-wave information (registered position information) at Step ST28 (No at Step ST28), the main control unit 7k performs a process of requesting the user to perform the authentication operation of changing the security level, for example, an operation of inputting a password via the operating unit 7d (Step ST31) and proceeds to the process of Step ST30.

The mobile communication terminal 7 according to the above-described embodiment includes: the terminal-side communication unit 7g that performs the power line communication based on the communication signal superimposed on the commercial power source 4; the process unit 7t of which a process is restricted in accordance with the security level; the waveform acquiring unit 7l that acquires the waveform included in the power received from the commercial power source 4; the storage unit 7j that stores, as registered waveform information, the waveform acquired in advance by the waveform acquiring unit 7l; the comparing unit 7o that compares the comparison waveform information, which is the information regarding the waveform received from the commercial power source 4 and acquired by the waveform acquiring unit 7l at the time of requiring the process of the process unit 7t, with the registered waveform information stored in the storage unit 7j; and the security level setting unit 7p that changes the security level based on the comparison result obtained by comparing the comparison waveform information with the registered waveform information by the comparing unit 7o. Accordingly, the mobile communication terminal 7 can improve the security.

The security level setting method according to the above-described embodiment is a security level setting method of the mobile communication terminal 7 which is able to perform power line communication based on the communication signal superimposed on the commercial power source 4 and is configured such that its process is restricted in accordance with the security level. The security level setting method includes: a step (Step ST12 and Step ST23) of acquiring the waveform included in the power received from the commercial power source 4; a step (Step ST12) of storing, as the registered waveform information, the waveform acquired in advance at the acquiring step (Step ST12); a step (Step ST24) of comparing the comparison waveform information which is the information regarding the waveform acquired at a step (Step ST23) of acquiring and receiving the power from the commercial power source 4 at the time of requiring the process, with the registered waveform information stored at the storing step (Step ST12); and a step (Step ST29) of changing the security level based on the comparison result obtained by comparing the comparison waveform information with the registered waveform information at the comparing step (Step ST24). Accordingly, the security level setting method can improve the security.

The security level setting program 7q according to the above-described embodiment causes the mobile communication terminal 7, which is able to perform power line communication based on the communication signal superimposed on the commercial power source 4 and is configured such that its process is restricted in accordance with the security level, to execute: a process (Step ST12 and Step ST23) of acquiring the waveform included in the power received from the commercial power source 4; a process (Step ST12) of storing, as the registered waveform information, the waveform acquired in advance at the acquiring step (Step ST12); a process (Step ST24) of comparing the comparison waveform information which is the information regarding the waveform acquired by a process (Step ST23) of acquiring and receiving the power from the commercial power source 4 at the time of requiring the process, with the registered waveform information stored by the storing process (Step ST12); and a process (Step ST29) of changing the security level based on the comparison result obtained by comparing the comparison waveform information with the registered waveform information by the comparing process (Step ST24). Accordingly, the security level setting program 7q can improve the security.

The power line communication device, the security level setting method, and the security level setting program according to the above-described embodiment are not limited thereto, but may be modified in various forms within the scope described in the claims.

In the mobile communication terminal 7 as the above-described power line communication device, the GPS information acquiring unit 7i may be used as a position information acquiring unit in substitution for the wireless communication unit 7a. In this case, the GPS information acquiring unit 7i acquires the GPS information as information corresponding to the position information of the mobile communication terminal 7. As described above, the GPS information includes information such as the latitude, the longitude, and the like of the mobile communication terminal 7. Therefore, the position information of the mobile communication terminal 7 can be specified based on the information.

In this case, the registering unit 7n stores and registers the GPS information acquired in advance by the GPS information acquiring unit 7i as the registered GPS information (corresponding to the registered position information) in association with the above-described registered waveform information in the information registration file 7r of the storage unit 7j. The GPS information is GPS information at a specific power reception position at which the mobile communication terminal 7 is used and is GPS information serving as a reference used to identify that the current actual position of the mobile communication terminal 7 is the position near the specific power reception position (specific connection position), when the mobile communication terminal 7 receives the power via the power conversion device 6 from the commercial power source 4. For example, the registering unit 7n registers the GPS information acquired by the GPS information acquiring unit 7i as the registered GPS information, when the mobile communication terminal 7 is connected to the power line network 3 via the power conversion device 6 at the specific power reception position (specific connection position) arbitrarily selected by the user or the like and receives the power via the power conversion device 6 from the commercial power source 4.

As in the case of the comparison between the comparison waveform information and the registered waveform information, the comparing unit 7o compares the comparison GPS information (corresponding to the comparison position information), which is the GPS information acquired by the GPS information acquiring unit 7i at the time of requiring the process of the process unit 7t, with the registered GPS information stored in the storage unit 7j. The security level setting unit 7p changes the security level used to restrict the process unit 7t based on the comparison result obtained by comparing the comparison GPS information with the registered GPS information by the comparing unit 7o.

Even in this case, the mobile communication terminal 7 can further improve the security by setting the security level automatically based on not only the waveform information of the noise component included in the power received from the commercial power source 4 but also the position information of the mobile communication terminal 7, in this embodiment, the GPS information.

The waveform of the noise component acquired by the above-described waveform acquiring unit 7l can be considered to be changed so as to have a predetermined tendency, when the use status or the like of the other devices 9 near the power reception position is changed in accordance with, for example, a period of time.

Accordingly, for example, the registering unit 7n may register the waveform of a noise component corresponding to a predetermined term such as one day as the registered waveform information. The comparing unit 7o can appropriately change the registered waveform information used for the comparison in accordance with the period of time to obtain the comparison result in consideration of a difference or the like in the use period of time. Thus, the mobile communication terminal 7 can improve the accuracy of the comparison of the comparing unit 7o, and thus can consequently improve the security.

The case has been described in which the restricting unit 7m restricts the process of the non-contact type IC card 7h in accordance with the security level. However, the restricting unit 7m may be configured to restrict the process of the wireless communication unit 7a, the voice unit 7b, the display unit 7c, the operating unit 7d, the terminal-side communication unit 7g, the GPS information acquiring unit 7i, or the like. The process restricted by the restricting unit 7m includes, for example, a process of writing/reading data, a process of acquiring/transmitting data through communication, a process of referring to/updating data, a process of inputting/outputting data through external connection, etc. Further, the unit of which the process is restricted in accordance with the security level by the restricting unit 7m is not limited to the process unit 7t. For example, a process of a reading unit that reads a predetermined file of the storage unit 7j may be restricted.

For example, when the restricting unit 7m restricts the process of the wireless communication unit 7a, the terminal-side communication unit 7g, the GPS information acquiring unit 7i, or the like in accordance with the security level, for example, the restricting unit 7m restricts the communication of the wireless communication unit 7a or the terminal-side communication unit 7g in accordance with the security level. For example, the process of the wireless communication unit 7a, the terminal-side communication unit 7g, and the GPS information acquiring unit 7i is restricted by the restricting unit 7m such that communication is regulated (prohibited) when the security level is relatively high. On the other hand, the operation of the wireless communication unit 7a, the terminal-side communication unit 7g, and the GPS information acquiring unit 7i is restricted by the restricting unit 7m such that the communication is allowed (permitted) when the security level is relatively low. In this case, the time of requiring the process of the process unit 7t is, for example, the time of requiring the communication using the wireless communication unit 7a, the terminal-side communication unit 7g, the GPS information acquiring unit 7i, or the like.

For example, when the restricting unit 7m restricts the process of the voice unit 7b, the display unit 7c, the operating unit 7d, or the like in accordance with the security level, for example, the restricting unit 7m restricts input and output of a voice by the voice unit 7b, the display information of the display unit 7c, input of a predetermined operation on the operating unit 7d, or the like in accordance with the security level. For example, when the security level is relatively high, the process of the voice unit 7b, the display unit 7c, or the operating unit 7d is restricted by the restricting unit 7m such that input and output of voice, display of predetermined information in the display unit 7c, or reception of a predetermined operation on the operating unit 7d is regulated (prohibited). On the other hand, when the security level is relatively low, the process of the voice unit 7b, the display unit 7c, or the operating unit 7d is restricted by the restricting unit 7m such that the input and output of voice, the display of predetermined information in the display unit 7c, or the reception of a predetermined operation on the operating unit 7d is allowed (permitted). In this case, the time of requiring the process of the process unit 7t is the time of outputting voice, displaying information, or inputting an operation using the voice unit 7b, the display unit 7c, the operating unit 7d, or the like.

The case has been described in which the power conversion device 6 and the mobile communication terminal 7 are configured separately. However, the power conversion device 6 and the mobile communication terminal 7 may be an integrated device. Alternatively, only a charging function may be loaded on the power conversion device 6 and the function of the modem 6b may be loaded on the mobile communication terminal 7. Alternatively, the power conversion device 6 may not have the charging function, but may have only the function of transmitting and receiving a communication signal.

For example, the mobile communication terminal 7 as the power line communication device may include the display unit 7c that is capable of displaying the coincidence between the comparison waveform information and the registered waveform information and the operating unit 7d to which an operation is input. The security level setting unit 7p may change the security level in response to the operation of the operating unit 7d. In this case, for example, when the coincidence between the comparison waveform information and the registered waveform information is relatively low, the mobile communication terminal 7 prompts the user to input an authentication operation by displaying the coincidence on the display unit 7c. The security level setting unit 7p can change the security level, when the authentication operation is input to the operating unit 7d.

The mobile communication terminal 7 as the power line communication device may include the voice unit 7b that can output the coincidence between the comparison waveform information and the registered waveform information and the operating unit 7d to which an operation is input. The security level setting unit 7p may change the security level based on the operation of the operating unit 7d. In this case, for example, the mobile communication terminal 7 can prompt the user to input the authentication operation by causing the voice unit 7b to output the coincidence as voice information, for example, when the coincidence between the comparison waveform information and the registered waveform information is relatively low. The security level setting unit 7p can change the security level, when the authentication operation is input to the operating unit 7d.

The mobile communication terminal 7 as the power line communication device may include the secondary cell 7f that can accumulate power. The security level setting unit 7p may change the security level to a high level, when the secondary cell 7f is charged. Thus, the mobile communication terminal 7 can improve the security when the secondary cell 7f is charged.

### INDUSTRIAL APPLICABILITY

The power line communication device, the security level setting method, and the security level setting program according to the embodiment are suitable to be applied to various power line communication devices, security level setting methods, and security level setting programs.

1. A power line communication device comprising:
a power line communication unit for performing power line communication based on a communication signal superimposed on a carrier wave transmitted via a power line of a commercial power source;
a process unit of which a process is restricted in accordance with a security level;
a waveform acquiring unit for acquiring a waveform of the communication signal included in the carrier wave transmitted via the power line of the commercial power source;
a storage unit for storing, as registered waveform information, waveform information corresponding to the waveform of the communication signal acquired in advance by the waveform acquiring unit;
a comparing unit for comparing the registered waveform information stored in the storage unit with comparison waveform information corresponding to the waveform, acquired by the waveform acquiring unit at the time of requiring the process of the process; and
a security level setting unit for changing the security level based on the comparison result obtained by comparing the registered waveform information with the comparison waveform information by the comparing unit.

2. The power line communication device according to claim 1, wherein
the waveform of the communication signal acquired by the waveform acquiring unit is a waveform of a noise component included in the carrier wave transmitted via the power line of the commercial power source.

3. The power line communication device according to claim 1, wherein
the power line communication unit is configured to perform the power line communication using a power waveform from a conversion device for converting the carrier wave transmitted via the power line of the commercial power source into the power waveform used for the power line communication, and
the waveform acquiring unit is configured to acquire the waveform included in the power waveform which is not yet converted by the conversion device.

4. The power line communication device according to claim 1, wherein
the process of the process unit is more restricted when the security level is relatively high rather than when the security level is relatively low.

5. The power line communication device according to claim 1, further comprising
a wireless communication unit for performing wireless communication with a base station, wherein
the storage unit is configured to store, as registered radio-wave information, radio-wave information acquired in advance from the base station by the wireless communication unit in association with the registered waveform information,
the comparing unit is configured to compare the registered radio-wave information stored in the storage unit with comparison radio-wave information which is radio-wave information acquired from the base station by the wireless communication unit at the time of requiring the process of the process unit, and
the security level setting unit is configured to change the security level further based on the comparison result obtained by comparing the registered radio-wave information with the comparison radio-wave information by the comparing unit.

6. The power line communication device according to claim 1, further comprising:
a GPS information acquiring unit for acquiring GPS information, wherein
the storage unit is configured to store the GPS information acquired in advance by the GPS information acquiring unit as registered GPS information in association with the registered waveform information,
the comparing unit is configured to compare the registered GPS information stored in the storage unit with comparison GPS information which is GPS information acquired by the GPS information acquiring unit at the time of requiring the process of the process unit, and
the security level setting unit is configured to change the security level further based on the comparison result obtained by comparing the registered GPS information with the comparison GPS information by the comparing unit.

7. The power line communication device according to claim 1,
the comparison result includes coincidence between the comparison waveform information and the registered waveform information, and
the security level setting unit is configured to
raise the security level to a relatively high level when the coincidence is relatively low, and
lowers the security level to a relatively low level when the coincidence is relatively high.

8. The power line communication device according to claim 7, wherein
the coincidence is expressed by a percentage of the degree of coincidence between the comparison waveform information and the registered waveform information.

9. The power line communication device according to claim 1, wherein
the process unit is configured to include an electronic money processing unit for treating electronic money, and
the electronic money processing unit is configured to restrict money to be treated in accordance with the security level, so that the money to be treated relatively decreases when the security level is relatively high, whereas the money to be treated relatively increases when the security level is relatively low.

10. The power line communication device according to claim 9, wherein
the comparison result includes coincidence between the comparison waveform information and the registered waveform information, and
the coincidence required so that the electronic money processing unit can be operated is set to be relatively high when remaining money is relatively much, whereas the coincidence required so that the electronic money processing unit can be operated is set to be relatively low when the remaining money is relatively small.

11. The power line communication device according to claim 1, further comprising:
an operating unit for inputting an authentication operation of changing the security level, wherein
the security level setting unit is configured to change the security level based on the authentication operation input to the operating unit.

12. The power line communication device according to claim 1, further comprising:
a secondary cell for accumulating power, wherein
the security level setting unit is configured to change the security level to a higher level when the secondary cell is charged.

13. A security level setting method of a power line communication device which is able to perform power line communication based on a communication signal superimposed on a carrier wave transmitted via a power line of a commercial power source and in which a process is restricted in accordance with a security level, the security level setting method comprising:
acquiring a waveform of the communication signal included in the carrier wave transmitted via the power line of the commercial power source;
storing, as registered waveform information, waveform information corresponding to the waveform of the communication signal acquired in advance in the acquiring of the waveform;
comparing the registered waveform information stored in the storing of the waveform information with comparison waveform information corresponding to the waveform acquired in the acquiring of the waveform at the time of requiring the process; and
changing the security level based on the comparison result obtained by comparing the registered waveform information with the comparison waveform information in the comparing.

14. A non-transitory storage medium that stores a security level setting program for causing, when executed by a power line communication device, which is able to perform power line communication based on a communication signal superimposed on a carrier wave transmitted via a power line of a commercial power source and in which a process is restricted in accordance with a security level, the power line communication device to execute:
acquiring a waveform of the communication signal included in the carrier wave transmitted via the power line of the commercial power source;
storing, as registered waveform information, waveform information corresponding to the waveform of the communication signal acquired in advance in the acquiring of the waveform;
comparing the registered waveform information stored in the storing of the waveform information with comparison waveform information corresponding to the waveform acquired in the acquiring of the waveform at the time of requiring the process; and
changing the security level based on the comparison result obtained by comparing the registered waveform information with the comparison waveform information in the comparing.
